(19) United States
(12) Patent Application Publication
(10) Pub. No.: US 2008/0062353 A1
(43) Pub. Date: Mar. 13, 2008

(54) Temperature compensation in liquid crystal tunable filters

(75) Inventor: Xinghua (Mark) Wang, Princeton, NJ (US)

Correspondence Address: MORGAN, LEWIS & BOCKIUS LLP, 1701 MARKET STREET, PHILADELPHIA, PA, 19103-2921, US

(73) Assignee: Chemlmage Corporation, Pittsburgh, PA (US)

(21) Appl. No.: 11/900,169

(22) Filed: Sep. 10, 2007

Related U.S. Application Data
(60) Provisional application No. 60/843,146, filed on Sep. 8, 2006.

(51) Int. Cl. G02F 1/133; G09G 3/36

(52) U.S. Cl. 349/72; 345/101

(57) ABSTRACT

A temperature compensation mechanism and associated methodology to provide compensation for temperature-induced drifts in the peak transmission wavelength of a liquid crystal (LC)-based tunable optical filter stage. The filter-staged based methodology uses a simple, empirical mathematical relationship that represents thermal effects on a liquid crystal-based filter stage by taking into account a relationship among the LC material's actual temperature coefficient (of thermal expansion), the operating temperature variation, and wavelength drift attributable to the temperature variation. In one embodiment, a control channel based mechanism is used to provides appropriate temperature compensation to a liquid crystal-based tunable optical filter by accurately calculating LC driving voltage values needed for temperature compensation and then supplying the calculated drive voltage to drive various LC components in the filter.

### REFERENCE TO RELATED APPLICATION

The disclosure in the present application claims priority benefit of the U.S. Provisional Application No. 60/843,146, titled “Thermal Effect of Multi-Conjugate Filter and Correction Algorithm Therefor,” and filed on Sep. 8, 2006.

### BACKGROUND

1. Field of the Disclosure

The present disclosure generally relates to liquid crystal-based tunable optical filters and systems employing such filters and, more particularly, to a system and method to provide temperature compensation in liquid crystal-based tunable optical filters to substantially minimize their wavelength drifts due to variations in operating temperature.

2. Brief Description of Related Art

Liquid crystals are widely used in many optical signal processing applications to accomplish desired signal outputs under external control, e.g., an electric field that controls the alignment of liquid crystals and, hence, the optical properties (e.g., birefringence) of the system employing such liquid crystals. Some devices based on liquid crystal technology include, for example, the popular liquid crystal display (LCD) monitors or computer screens. On the other hand, in many modern spectroscopy systems, liquid crystal-based tunable optical filters (LCTFs) are used to optically filter a desired spectral wavelength or a range of wavelengths for further analysis by a spectrometer operating in conjunction with the filter. The “tuning” of wavelengths may be accomplished by providing appropriate drive voltages to the LC elements in the filter.

Two major competing factors that influence the temperature performance of a liquid crystal-based optical filter are: (1) The thermal expansion of the optical cavity for the liquid crystal variable retarder in the filter, and (2) Change in the birefringence of the liquid crystal (LC) material as a function of temperature.

The first part—i.e., the thermal expansion effect—may be very difficult to estimate because it depends on the engineering details of how the LC component is built. For example, if the optical cavity increases as the temperature rises, the effective retardation/birefringence of the LC component will increase as well. The second factor—i.e., the change in birefringence—works in opposite direction. The birefringence of a liquid crystal is related to the order parameter “S” of the liquid crystal material. For an isotropic LC sample, S=0; whereas for a perfectly aligned LC sample, S=1. For a typical liquid crystal sample, “S” may be on the order of 0.3 to 0.8, and may generally decrease as the temperature is raised. A sharp drop of the order parameter “S” to value “0” may be observed when the LC system undergoes a phase transition from an LC phase into its isotropic phase. The order parameter “S” may be measured experimentally using, for example, Raman scattering, birefringence, or diamagnetism techniques.

The order parameter “S” is related to the temperature difference between the environmental temperature “T” and the nematic to isotropic transition temperature “T_{NI}” of LC (i.e., the temperature at which the liquid crystal material transitions from the nematic phase into the isotropic phase). When the environment temperature is far away from the nematic to isotropic transition temperature and the crystallization temperature, that relationship may be represented as a linear relationship:
Δn˜(1−T/T_{NI}) (1)
In equation (1), “Δn” represents the difference between the ordinary and extraordinary refractive indices of the liquid crystal birefringent material. It is seen from equation (1) that there is a linear relationship between the environmental temperature “T” and the differential refractive index “Δn.” Thus, any fluctuations in the environmental temperature “T” would reflect as changes in “Δn”, which, in turn, would manifest as a drift in the transmission peak wavelength of the liquid crystal device in an optical filter. Such wavelength drift is undesirable because it degrades the performance of the liquid crystal-based optical filter.

It is very complex to describe the temperature effect analytically by considering the net results of the two effects (i.e., the effects of thermal expansion and birefringence change mentioned above). However, the way the LC components are designed and constructed provides relatively stable thermal expansion for the LC chamber thickness. Thus, the overall effect of the temperature stability is highly repeatable during various operational iterations. Hence, it is desirable to devise a methodology that provides a simple mathematical representation of thermal effects on a liquid crystal-based filter stage by taking into account a relationship between the LC material's actual temperature coefficient (of thermal expansion) and the operating temperature variation. It is further desirable to devise a system and method that provides appropriate temperature compensation to a liquid crystal-based tunable optical filter by accurately calculating LC driving voltage values needed for temperature compensation and then supplying the calculated drive voltage to drive various LC components in the filter.

### SUMMARY

In one embodiment, the present disclosure relates to a method that comprises sensing an operating temperature of a filter stage of a liquid crystal-based tunable optical filter, and determining a difference temperature by subtracting a calibration temperature from the operating temperature, wherein the calibration temperature indicates a temperature value at which the tunable optical filter is calibrated. The method further comprises calculating a wavelength drift of the filter stage corresponding to the difference temperature by using an empirical relationship between the difference temperature and the wavelength drift, wherein the wavelength drift indicates a deviation from a predetermined peak wavelength of the filter stage at the calibration temperature. The method also comprises providing a compensation for the calculated wavelength drift by adjusting a driving voltage of the filter stage commensurate with the value of the wavelength drift so as to substantially minimize the wavelength drift at the operating temperature from the predetermined peak wavelength.

In one embodiment, the empirical relationship is represented by a mathematical equation given by: Δλₚ=γΔTλₛₑₜ, wherein “Δλₚ” represents the wavelength drift, “γ” represents a predetermined temperature coefficient of the filter stage, “ΔT” represents the difference temperature, and “λₛₑₜ” represents the predetermined peak wavelength.

In an alternative embodiment, the present disclosure relates to a system, which comprises a liquid crystal-based tunable optical filter having a filter stage containing a plurality of liquid crystal elements; a temperature sensor for sensing an operating temperature of the filter stage; and a control unit configured to receive the operating temperature from the temperature sensor. The control unit is further configured to perform the various method steps (e.g., determining the difference temperature, calculating the wavelength drift, and providing a compensation for the calculated wavelength drift) recited above.

In a further embodiment, the present disclosure relates to a data storage medium containing program code, which, when executed by a processor, causes the processor to obtain from a temperature sensor an operating temperature of a filter stage of a liquid crystal-based tunable optical filter, and then to perform the various method steps (e.g., determining the difference temperature, calculating the wavelength drift, and providing a compensation for the calculated wavelength drift) recited above.

A liquid crystal-based tunable optical filter according to one embodiment of the present disclosure comprises a filter housing, which includes a filter stage, a temperature sensor for sensing an operating temperature of the filter stage, and a control unit configured to receive the operating temperature from the temperature sensor. The filter stage comprises a plurality of paired birefringent retarders disposed between at least two polarizers, wherein each paired retarder includes a fixed retarder and a liquid crystal tunable retarder, and wherein each liquid crystal retarder is tunable independently of other liquid crystal retarders in the filter stage. The control unit is configured to determine a difference temperature by subtracting a calibration temperature from the operating temperature, wherein the calibration temperature indicates a temperature value at which the tunable optical filter is calibrated. The control unit is further configured to calculate a wavelength drift of the filter stage corresponding to the difference temperature by using an empirical relationship between the difference temperature and the wavelength drift, wherein the wavelength drift indicates a deviation from a predetermined peak wavelength of the filter stage at the calibration temperature. The control unit is also configured to provide a compensation for the calculated wavelength drift by adjusting driving voltages of liquid crystal retarders in the filter stage commensurate with the value of the wavelength drift so as to substantially minimize the wavelength drift at the operating temperature from the predetermined peak wavelength.

In yet another embodiment, the present disclosure relates to a programmable processor, which, upon being programmed, is configured to perform the following: obtain from a temperature sensor an operating temperature of a filter stage of a liquid crystal-based tunable optical filter; determine a difference temperature by subtracting a calibration temperature from the operating temperature, wherein the calibration temperature indicates a temperature value at which the tunable optical filter is calibrated; calculate a wavelength drift of the filter stage corresponding to the difference temperature by using a mathematical relationship given by: Δλₚ=γΔTλₛₑₜ, wherein “Δλₚ” represents the wavelength drift, “γ” represents a predetermined temperature coefficient of the filter stage, “ΔT” represents the difference temperature, and “λₛₑₜ” represents a predetermined peak wavelength of the filter stage at the calibration temperature, wherein the wavelength drift indicates a deviation from the predetermined peak wavelength; and provide a compensation for the calculated wavelength drift by adjusting a driving voltage of the filter stage commensurate with the value of the wavelength drift so as to substantially minimize the wavelength drift at the operating temperature from the predetermined peak wavelength.

The present disclosure describes various embodiments of a temperature compensation mechanism and associated methodology to provide compensation for temperature-induced drifts in the peak transmission wavelength of a liquid crystal (LC)-based tunable optical filter stage. The filter-staged based methodology uses a simple, empirical mathematical relationship that represents thermal effects on a liquid crystal-based filter stage by taking into account a relationship among the LC material's actual temperature coefficient (of thermal expansion), the operating temperature variation, and wavelength drift attributable to the temperature variation. In one embodiment, a control channel based mechanism is used to provides appropriate temperature compensation to a liquid crystal-based tunable optical filter by accurately calculating LC driving voltage values needed for temperature compensation and then supplying the calculated drive voltage to drive various LC components in the filter. The teachings of the present disclosure may be implemented whenever filtering properties of liquid crystals are utilized such as, for example, in a liquid crystal display (LCD), in a liquid crystal tunable-filter based spectroscopy system, etc.

### BRIEF DESCRIPTION OF THE DRAWINGS

For the present disclosure to be easily understood and readily practiced, the present disclosure will now be described for purposes of illustration and not limitation, in connection with the following figures, wherein:

FIGS. 1A and 1B illustrate a comparison of measured and modeled transmission spectra of an exemplary Lyot filter at two different operating temperatures;

FIG. 2 shows the electro-optical response plots of an exemplary liquid crystal-based tunable optical filter when the command (or drive) voltage of the filter is plotted versus the filter's transmission peak wavelength as a function of temperature;

FIG. 3 illustrates three clusters of data points showing the peak drift of an exemplary filter stage measured as a function of different temperatures;

FIG. 4 illustrates exemplary sets of plots of peak drifts of a filter stage as a function of control voltage applied to that filter stage;

FIG. 5 depicts a schematic block diagram of an exemplary spectroscopy system employing temperature compensation according to one embodiment of the present disclosure;

FIG. 6 shows an exemplary LC-based filter stage having four liquid crystal variable retarder elements sandwiched between two polarizers and wherein the temperature compensation methodology according to the teachings of the present disclosure may be employed;

FIG. 7 illustrates an exemplary liquid crystal-based multi-conjugate filter stage wherein the temperature compensation methodology according to the teachings of the present disclosure may be employed;

FIG. 8 shows an exemplary temperature effect compensation arrangement according to one embodiment of the present disclosure in a liquid crystal-based tunable filter stage having four liquid crystal elements;

FIG. 9 illustrates another exemplary temperature effect compensation arrangement according to one embodiment of the present disclosure in a liquid crystal-based tunable filter stage having six liquid crystal elements;

FIG. 10 shows illustrative electro-optical response plots of an exemplary filter stage over a range of control (drive) voltages for that filter stage; and

FIG. 11 illustrates transmission plots over a wide range of operating temperatures of an exemplary LC-based tunable filter stage employing temperature compensation mechanism according to one embodiment of the present disclosure.

### DETAILED DESCRIPTION

The accompanying figures and the description that follows set forth the present disclosure in embodiments of the present disclosure. However, it is contemplated that persons generally familiar with liquid crystal optics, operation and maintenance of optical instruments (including spectroscopic instruments), or optical spectroscopy will be able to apply the teachings of the present disclosure in other contexts by modification of certain details. Accordingly, the figures and description are not to be taken as restrictive of the scope of the present disclosure, but are to be understood as broad and general teachings. In the discussion herein, when any numerical range of values is referred or suggested, such range is understood to include each and every member and/or fraction between the stated range of minimum and maximum.

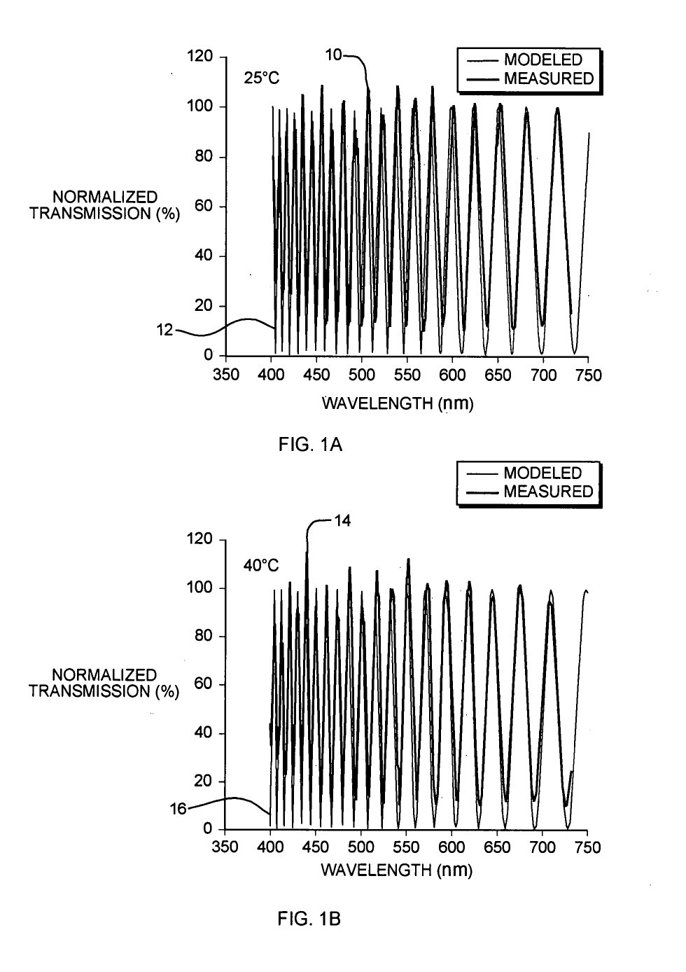

FIGS. 1A and 1B illustrate a comparison of measured and modeled transmission spectra of an exemplary Lyot filter (not shown) at two different operating temperatures. The spectra 10 and 12 in FIG. 1A relate to the operating temperature of 25° C., whereas the spectra 14 and 16 in FIG. 1B are for the operating temperature of 40° C. The dotted spectra in both the figures indicate the modeled versions of the measured spectra that are shown in solid lines. Thus, the spectra 10, 12, 14, and 16 in FIGS. 1A-1B provide an illustration of the thermal effect on a liquid crystal (LC) component in a Lyot filter (not shown) having a quartz retarder and one LC component laminated together. If the thermal effect in the Lyot filter is modeled by assuming that the total effective refractive index (of the combination that includes the quartz retarder and the LC component) is a linear function of temperature variation, as given by Eq. (1), then the measured data (the spectra in solid lines) agree very well with the modeled data (the spectra in dotted lines) in that all the peak positions register within 1/20 FWHM (Full Width at Half Maximum).

However, it can be seen from a comparison of spectra in FIGS. 1A and 1B that, at different temperatures, the transmission peaks may shift by as large as ⅓ FWHM if no temperature compensation mechanism is engaged to compensate for thermal effects on the LC component of the filter. In case of a Solc filter or a multi-conjugate filter (MCF) configuration, the wavelength drift may be as high as 1˜2 FWHM at 40° C. Some exemplary MCF configurations are discussed in the United States Patent Application Publication No. US 2007/0070260 A1, titled “Liquid Crystal Filter with Tunable Rejection Band.”

It is observed here that the above modeling in equation-I gives no guidance in determining the driving scheme for an LCTF (Liquid Crystal Tunable Filter) unit in an MCF to compensate for any temperature variation. The above modeling (in equation-1) simply confirms that it is possible to understand how the temperature changes the optical properties of the liquid crystal optical components.

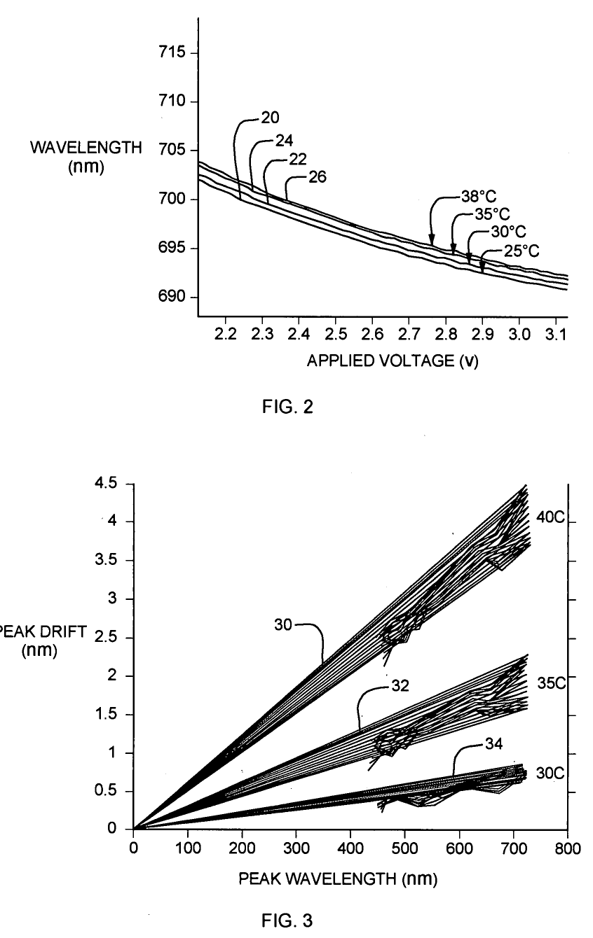

To determine how one can drive a liquid crystal-based optical filter (e.g., an LCTF) to compensate for thermal effects, it may be more practical to first measure the electro-optical response of the filter. In one embodiment, when the command (or drive) voltage of an exemplary liquid crystal-based tunable optical filter (e.g., an MCF) (not shown) is plotted versus the filter's transmission peak wavelength as a function of temperature, the electro-optical response may be as shown in FIG. 2. In FIG. 2, the reference numeral “20” identifies the plot at 25° C., the reference numeral “22” relates to the plot at 30° C., the reference numeral “24” refers to the plot at 35° C., and the reference numeral “26” is used to identify the plot at 38° C. It is seen from the plots 20, 22, 24, and 26 in FIG. 2 that, at different temperatures, the electro-optical response (i.e., transmission peak) is shifted even when there is no change in the drive voltage. However, the drift in the electro-optical response is very consistent with temperature. It may be desirable to establish a mathematical relationship between the temperature coefficient (of thermal expansion) of a liquid crystal retarder in an optical filter and the environmental (operating) temperature.

In one embodiment, an empirical relationship, as given by equation (2) below, may be derived to describe the thermal effect on liquid crystal retarders in any stage of an LC-based tunable optical filter (e.g., an LCTF or an MCF).
Δλₚ=γΔTλₛₑₜ (2)
In the above equation, “Δλₚ” is the drift in wavelength peak position (from the set wavelength), “λₛₑₜ” is the set wavelength (to which the filter stage is tuned), “T” is the operating (environmental) temperature, ΔT=T−25° C. is the temperature difference from the calibration temperature (25° C.), and “γ” is a predetermined temperature coefficient (of thermal expansion) of the filter stage. In one embodiment, the unit of the “γ” is ppm/° C. or parts per million per degree. As is known in the art, the calibration temperature may vary from one filter design to another, but, in any event, the calibration temperature refers to the temperature at which the liquid crystal-based filter is calibrated to operate. Various filter parameters may also be specified with respect to the calibration temperature. For example, the value of the filter stage peak transmission wavelength λₛₑₜ may refer to the value at the calibration temperature. Thus, in a temperature compensation application, it may be desirable to reduce the temperature-induced wavelength drifts so as to obtain transmission peak wavelength at a given operating temperature that is substantially close to the set wavelength (λₛₑₜ) at the calibration temperature.

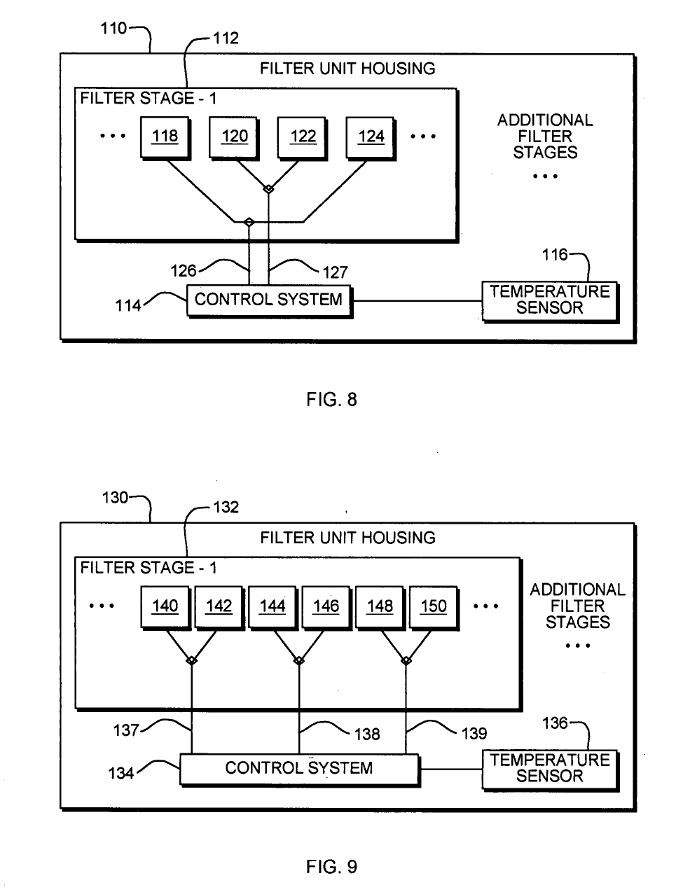

In one embodiment, the present disclosure relates to providing a temperature compensation mechanism based on the empirical relationship given in equation (2) above as discussed later hereinbelow with reference to FIGS. 8-11.

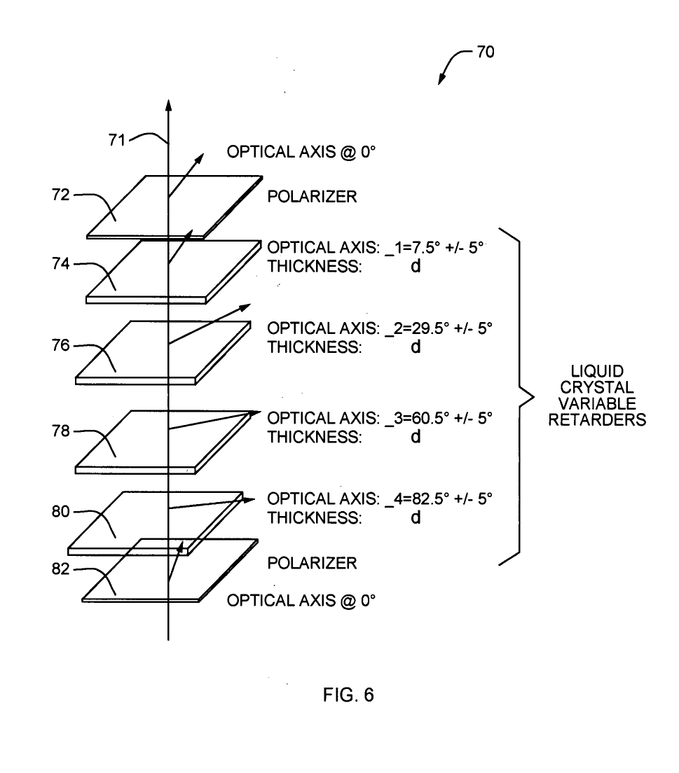

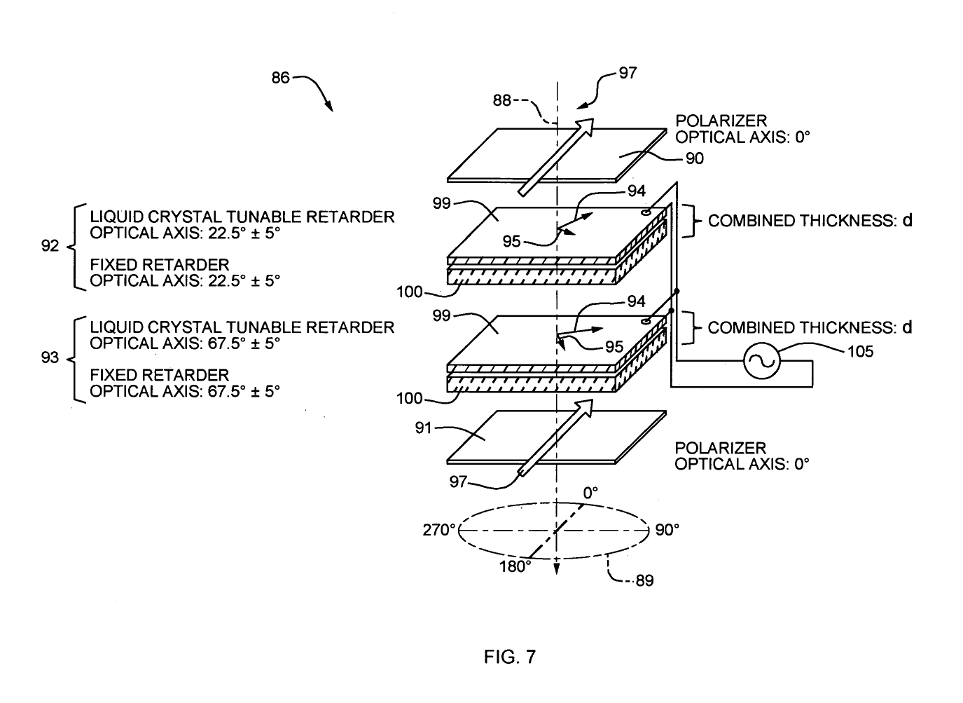

It is seen from equation (2) that there is a linear relationship between the wavelength drift (Δλₚ) and the operating temperature (as represented by the parameter ΔT) as well as the set wavelength (e.g., the peak transmission wavelength) of an LC-based optical filter stage. Hence, the empirical relationship in equation (2) comports in nature with the linear relationship given in equation (1) above. However, it still may be desirable to verify that the empirical relationship given by equation (2) and the derivation in equation (1) are indeed linear relationships in practice. To carry out such verification, in one embodiment, a filter stage (exemplary filter stages are depicted in FIGS. 6-7) with FWHM≈10 nm was used. If the peak drift of this filter stage is measured as a function of different temperatures, the clusters of data points that correspond to peak positions at 450 nm-730 nm may be as shown in FIG. 3. In the embodiment of FIG. 3, the last stage of a fluorescence multi-conjugate filter (Model: FluoMCFD504, designed by ChemImage Corporation of Pittsburgh, USA) was selected for these peak drift measurements. In FIG. 3, three clusters of data points 30, 32, and 34 are shown to represent data points measured at operating temperature values of 40° C., 35° C., and 30° C., respectively. In the embodiment of FIG. 3, the calibration temperature is 25° C. Thus, the plots 30, 32, and 34 were plotted at 5° C. steps from the calibration temperature. It is noted here that there are many data points in the graphs in FIG. 3 because the filter stage being used had many transmission peaks across the visible spectrum (e.g., similar to the multiple transmission peaks in the measured spectra in FIGS. 1A and 1B).

It is seen from the plots 30, 32, and 34 in FIG. 3 that all the data points for peak drift versus peak wavelength plots fall into the expected (substantially) linear relationship, which may be mathematically represented by the empirical relationship in equation (2) according to one embodiment of the present disclosure and also alternatively represented by the derivation in equation (1). With the data points in FIG. 3, it may be possible to determine the temperature coefficient of thermal expansion “γ” of the filter stage using equation-2. Table-1 below provides a set of values for “γ” determined as described hereinabove for an exemplary liquid crystal-based tunable optical filter design (which may include one or more filter stages wherein each stage may be similar to that shown in FIG. 7).

TABLE 1

| Design No. | Stage No. | γ (ppm/° C.) |
|---|---|---|
| FluoMCFD504 | 1 | 2350 +/− 300 |
| | 2 | 2350 +/− 300 |
| | 3 | 1140 +/− 130 |
| | 4 | 380 +/− 50 |

It is observed here that the temperature coefficient values in Table-1 above are exemplary only, and they relate to a fluorescence multi-conjugate filter model “FluoMCFD504” designed by ChemImage Corporation, Pittsburgh, USA. It is noted here that the measured temperature coefficient values in Table-1 (which may be measured or computed using, for example, data points from the corresponding peak drift vs. peak wavelength plots) are different for each filter stage in the MCF design. Thus, stage-by-stage measurements may need to be carried out to obtain each filter stage-specific temperature coefficient values. These values of “γ” for each filter stage may be predetermined during filter design stage and stored in a control unit (e.g., the control system 114 in FIG. 8 or the control system 134 in FIG. 9 discussed later hereinbelow) for use in temperature compensation calculations (according to equation-2) during run time.

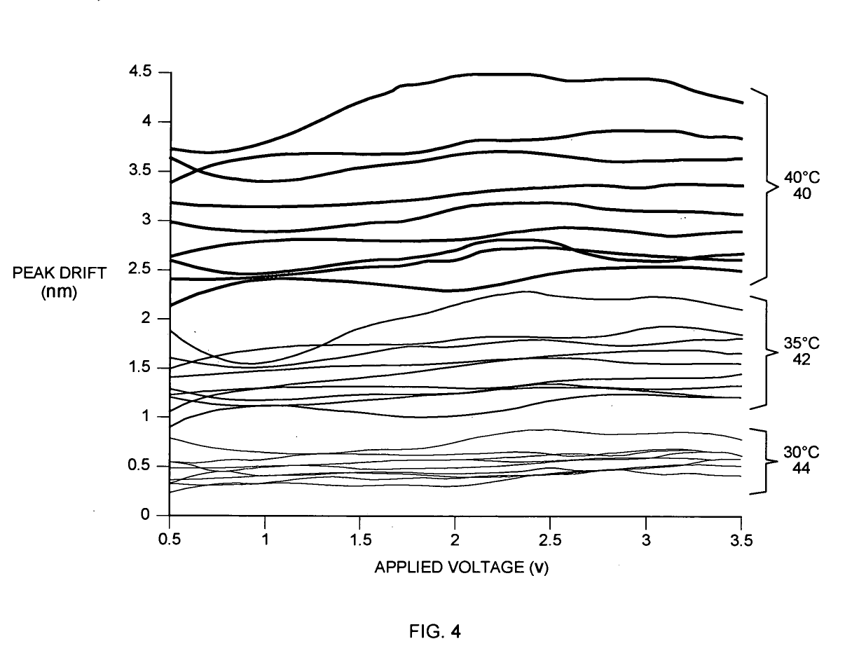

It is noted here that the empirical relationship given by equation (2) does not include a parameter representing the driving or control voltage for the filter stage. In other words, equation (2) indicates that the peak drift (Δλₚ) of a filter stage may be independent of the driving voltage applied to that stage. Hence, it may be desirable to verify whether the peak drift representation in equation (2) is indeed independent of the driving (or control) voltage. FIG. 4 illustrates exemplary sets of plots 40, 42, 44 of peak drifts of a filter stage as a function of control voltage applied to that filter stage. In the embodiment of FIG. 4, the last stage of a fluorescence multi-conjugate filter (Model: FluoMCFD504, designed by ChemImage Corporation of Pittsburgh, USA) was selected for these peak drift measurements. In FIG. 4, each set 40, 42, 44 includes a number of plots representing peak drift of the filter stage as a function of the applied voltage at a specific operating temperature. For example, the set of plots 40 contains plots at 40° C. operating temperature, the set 42 has plots corresponding to 35° C. operating temperature, and the set of plots 44 are plotted at the operating temperature of 30° C. In the embodiment of FIG. 4, the calibration temperature is 25° C. Thus, the sets of plots 40, 42, and 44 were plotted at 5° C. steps from the calibration temperature. It is observed with respect to the various plots in FIG. 4 that, within an accuracy of 0.5 nm ( 1/20 FWHM, where FWHM=10 nm), the peak drift of the filter stage is substantially independent of control voltage (i.e., the peak drift plots may be considered substantially horizontal in FIG. 4 within the specified accuracy tolerance). The sets of plots 40, 42, and 44 in FIG. 4 thus verify that the temperature compensation relationship given by the empirical equation (2) only depends on the environmental (operating) temperature and is substantially independent of the filter stage's driving voltage.

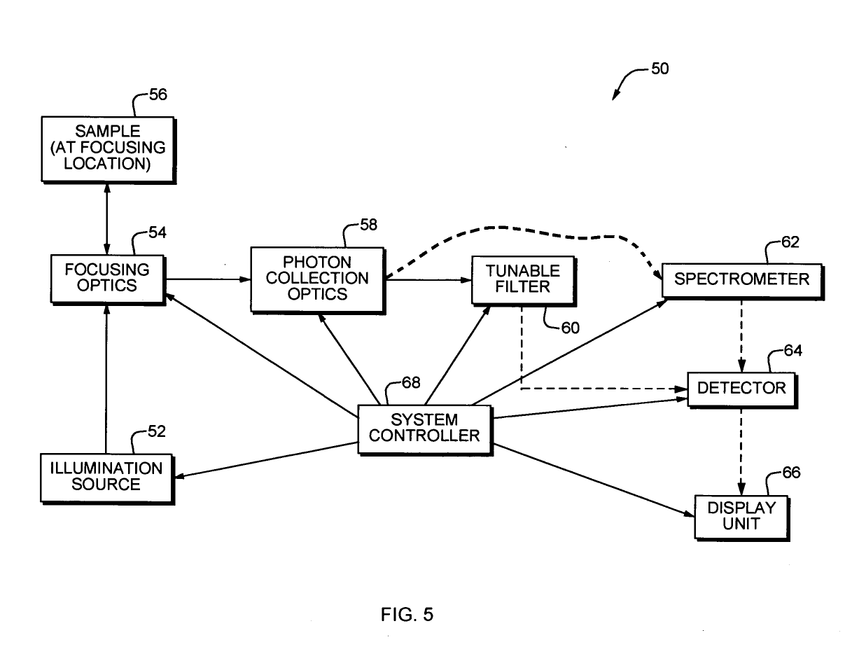

FIG. 5 depicts a schematic block diagram of an exemplary spectroscopy system 50 employing temperature compensation according to one embodiment of the present disclosure. The spectroscopy system 50 may be used, for example, for Raman and/or fluorescence spectroscopy applications. In one embodiment, the system 50 is a handheld, portable unit. The system 50 may include an illumination source 52 (e.g., a laser diode, or an LED) that provides illuminating photons to a focusing optics 54. The wavelength of the illuminating photons may be in the visible wavelength range, UV (ultraviolet) wavelength range, or infrared wavelength range as per desired application. In one embodiment, the focusing optics 54 may include a single lens (not shown) or a combination of two or more lenses (not shown). When a sample 56 is placed at a focusing location of the focusing optics 54, the illuminating (or excitation) photons from the illumination source 52 are directed onto the sample 56 through the focusing optics 54. The sample 56 may interact with the illuminating photons to provide reflected, scattered, or emitted photons, which photons may be initially collected by the focusing optics 54 and transferred to a photon collection optics 58. In one embodiment, the photon collection optics 58 may include another lens assembly either alone or in combination with a laser line rejection filter (not shown). The laser line rejection filter may operate to reject photons reflected from the sample 56 and having the wavelength of the illuminating photons.

The photon collection optics 58 may direct the Raman scattered or fluorescence (emitted) photons received from the sample to a liquid crystal-based optical tunable filter 60. The tunable filter 60 may filter the photons received from the collection optics 58 to provide only those photons that have wavelengths substantially within the transmission passband of the tunable filter 60. It is noted here that although the discussion given herein primarily focuses on embodiments of the tunable filter 60 having bandpass characteristics, the tunable filter 60 may be a bandstop filter (having a tunable rejection stopband) instead as per the desired application. Some exemplary LC-based optical tunable filter stages are discussed hereinbelow with reference to FIGS. 6 and 7. The tunable filter 60 may include a temperature compensation mechanism (not shown in FIG. 5) according to the teachings of the present disclosure as discussed later hereinbelow with reference to FIGS. 8 and 9. Alternatively or in addition to the tunable filter 60, a dispersive (e.g., gratings-based) spectrometer 62 may be provided to receive the collected photons from the photon collection optics 58 and to generate a spectrum of the sample 56 under investigation over a selected spectral range of interest.

In an imaging embodiment, the spectroscopy system 50 may optionally include a detector 64 optically coupled to the spectrometer 62 or tunable filter 60 to generate data that can be used to display a spectral image of the sample 56. The detector 64 may receive an optical output (e.g., a wavelength-dispersed optical signal in case of the dispersive spectrometer 62 or a wavelength-specific spectral output in case of the liquid crystal-based tunable filter 60) and generate signal data therefrom. The signal data may be supplied to an electronic display unit 66 to display a wavelength-specific spectral image of the sample 56 under investigation. In one embodiment, the detector 64 may be a part of a spectrometer unit, in which case, the spectrometer 62 may include the functionality of the detector 64. In one embodiment, the detector 64 may be a charge coupled device (CCD). In another embodiment, the detector 64 may be a complementary metal oxide semiconductor (CMOS) array. In an alternative embodiment, the display unit 66 may be a computer display screen, a display monitor, or an LCD (liquid crystal display) screen. It may be evident to one skilled in the art that the temperature compensation methodology discussed herein in conjunction with an LC-based optical tunable filter may be appropriately adapted to apply to LC elements in other liquid-crystal based devices including, for example, an LCD display screen or other LC-based devices where optical filtering properties of liquid crystals are employed.

The spectroscopy system 50 may also include a programmable system controller 68, which can be suitably programmed to electronically control functionalities of one or more of the system elements including, for example, the illumination source 52, the focusing optics 54, the collection optics 58, the tunable filter 60, the spectrometer 62, the detector 64, and the display unit 66 as shown by the exemplary illustration in FIG. 5. The controller 68 may be a computing or data processing unit that can be suitably programmed for collecting and processing spectral information from the samples under investigation. In one embodiment, the controller 68 may be configured to apply the temperature compensation methodology according to the teachings of the present disclosure. In such an embodiment, a dedicated controller (e.g., the control system 114 in FIG. 8 or the control system 134 in FIG. 9) may be absent from a filter housing (discussed later in conjunction with FIGS. 8-9); rather, the functionality of such a dedicated controller (discussed later herein below) may be accomplished through the system controller 68 using an appropriate circuit configuration as may be evident to one skilled in the art.

FIG. 6 shows an exemplary LC-based filter stage 70 having four liquid crystal variable retarder elements 74, 76, 78, 80 sandwiched between two polarizers 72, 82. The temperature compensation methodology discussed hereinbelow with reference to FIG. 8, for example, may be applied to the LC retarders 74, 76, 78, and 80 in the filter stage 70. Therefore, additional discussion of temperature compensation in the filter stage 70 in FIG. 6 is not provided herein in conjunction with the discussion of FIG. 6. The filter stage 70 may be used as part of the tunable filter unit 60 in the embodiment of FIG. 5. It is observed here that all liquid crystal retarders in the embodiment of FIG. 6 are of the same thickness (“d”), but different optical axis orientations (“θ”) as shown in FIG. 6. The birefringent LC elements 74, 76, 78, and 80 are shown to be in a symmetrical array of rotational angles, encompassing 90° C. of span in a bandpass configuration where the polarizers 72, 82 are parallel to the LC elements. The optical axes of the input polarizer 82 and the exit polarizer 72 may provide the reference angle (0°) with respect to the direction of propagation of the incoming light (shown by a vertical arrowed line 71 in FIG. 6) and against which the relative angles (“θ”) of optical axes of liquid crystal elements may be measured. In the embodiment of FIG. 6, orientation angles of optical axes of the two middle LC components 76, 78 symmetrically add up to 90° (60.5°+29.5°). The same rotational symmetry (between relative angles of optical axes of LC elements) is present between the two “outer” elements 74, 80 (7.5°+82.5°=90°). In one embodiment, the liquid crystal retarders 74, 76, 78, and 80 may be tuned in unison in a manner similar to that illustrated with reference to the embodiment in FIG. 7.

FIG. 7 illustrates an exemplary liquid crystal-based multi-conjugate filter stage 86 wherein the temperature compensation methodology according to the teachings of the present disclosure may be employed. The filter stage 86 may be used as part of the tunable filter unit 60 in the embodiment of FIG. 5. It is observed here that the exemplary embodiments in FIGS. 6 and 7 are isometric projections that are exploded in that the optical elements are shown spaced apart from one another, whereas, in an actual embodiment, various filter elements are abutted directly against one another. The direction of light propagation is vertical along axis 88. The respective optical elements are shown placed normal to the axis 88. The light propagation may be upward or downward, but, for convenience, it is assumed to be downward in FIG. 7.

A projected circle 89 is shown in FIG. 7 as a reference that can be used in discussing the relative rotational orientations of the optical elements relative to one another around the axis 88. Reference circle 89 is shown only for convenience of explanation. The angular orientations illustrated in FIG. 7 refer specifically to optical orientations rather than to the orientation of the edges of the optical elements. The optical elements in the filter stage 86 include an entrance or input polarizer 90, a selection or output polarizer 91, and two tunable birefringent elements 92, 93 that are oriented at different optical alignments around axis 88. Each birefringent element 92, 93 has a fast axis 94 and a slow axis 95 that are orthogonal to each other and also to the propagation axis 88. The vector light components propagate at different speeds along the axes 94 and 95. The retardation imparted by birefringent elements 92, 93 can produce a rotation in polarization orientation (for certain wavelengths at the input of the filter stage), which, if carried on through each element of the filter stage 86, provides an output wherein those wavelengths are substantially exclusively aligned to the selection polarizer 91 and are transmitted (e.g., to the next filter stage or as an output of the entire filter assembly).

In the embodiment of FIG. 7, each birefringent element 92, 93 is shown to include a fixed retarder 100 and a tunable liquid crystal retarder 99 in optical alignment with the fixed retarder 100 (i.e., fast and slow axes of the tunable retarder are parallel to respective fast and slow axes of the fixed retarder) and abutted against it, thereby forming a pair 92, 93 with an optical orientation (“θ”) and a combined thickness of “d.”. In the embodiment of FIG. 7, the polarizers 90, 91 are shown to have reference optical orientation 97 at 0°, whereas the optical orientations of elements 92, 93 are given relative to this reference orientation. Similar to the embodiment in FIG. 6, the optical orientations of birefringent elements in the embodiment of FIG. 7 are symmetrical and add up to 90° as can be seen from the angular values in FIG. 7. It can be assumed that the 22.5° and 67.5° angular values in FIG. 7 represent angular values for the orientations of fast axes of respective birefringent element 92, 93. It is noted here that polarization components from the input polarizer 90 or a given birefringent element along the optical propagation path 88 may be coupled in unequal proportions to the fast and slow axes of the next birefringent element. The selection polarizer 91 can be aligned to obtain a band pass filter configuration or a band stop filter configuration as desired.

As mentioned before, some exemplary MCF configurations are discussed in the United States Patent Application Publication No. US 2007/0070260 A1, titled “Liquid Crystal Filter with Tunable Rejection Band.” Additional discussion of multi-conjugate filter designs may be obtained from the WIPO (World Intellectual Property Organization) Publication No. WO/2006/116031, published on Nov. 2, 2006.

In FIG. 7, each birefringent element 92, 93 is of equal thickness “d.” Furthermore, the dimensions and birefringence of fixed retarders 100 are unchangeable. However, the birefringence of tunable liquid crystals 99 can be electrically controlled in unison by a driving voltage source 105. Applying a voltage to increase the birefringence of the liquid crystals increases the difference in optical refractive indices in the liquid crystal, which is, in effect, similar to making the birefringent elements 92, 93 thicker (i.e., effectively changing one of its dimensions). A reduction in applied driving voltage may affect liquid crystal elements in the opposite manner. As discussed hereinbelow with reference to FIGS. 8 and 9, temperature compensation may be accomplished by appropriately changing the driving voltages of liquid crystal elements in a filter stage as per the teachings of the present disclosure. In case of the embodiment in FIG. 7, the driving voltage output by the voltage source 105 may be suitably controlled to compensate for temperature effects in a manner similar to that discussed below with reference to the embodiments in FIGS. 8 and 9 (which discussion can be also applied to the configuration in FIG. 7). Therefore, additional discussion of temperature compensation in the filter stage 86 in FIG. 7 is not provided herein.

It may be evident to one skilled in the art that the filter stages 70 and 86 in FIGS. 6 and 7, respectively, are just examples of different types of filter stages that may be suitable for employing the temperature compensation mechanism according to the teachings of the present disclosure. In practice, such temperature compensation may be applied to different types of liquid crystal-based filters (whether bandpass or bandstop) than those illustrated in FIGS. 6 and 7. Furthermore, the exemplary filter stages 70 or 86 may be cascaded in certain filter configurations to accomplish the desired wavelength filtering effect. In such embodiments, stage-wise temperature compensation may be employed (as discussed below with reference to FIGS. 8-9). Additionally, in certain actual filter configurations, the number of liquid crystal elements (whether conjugated with corresponding fixed retarders or not) per stage may be different from the number depicted in the exemplary embodiments in FIGS. 6-7.

FIG. 8 shows an exemplary temperature effect compensation arrangement according to one embodiment of the present disclosure in a liquid crystal-based tunable filter stage 1 12 having four liquid crystal elements 118, 120, 122, and 124. FIG. 9, on the other hand, illustrates another exemplary temperature effect compensation arrangement according to one embodiment of the present disclosure in a liquid crystal-based tunable filter stage 132 having six liquid crystal elements 140, 142, 144, 146, 148, and 150. Thus, FIGS. 8 and 9 depict two embodiments of LC-based tunable optical filters having temperature compensation according to the teachings of the present disclosure. In FIG. 8, the tunable filter elements and accompanying sensor and control systems are shown housed in a filter unit housing 110. In FIG. 9, the filter housing is indicated by reference numeral “130.” There may be more than one filter stage in each filter design 110, 130 as indicated by a dotted line in the respective FIG. 8 and 9. Also, each filter stage may include other filter elements (e.g., fixed retarders, polarizers, etc.) besides the LC retarders, as indicated by other dotted lines within corresponding filter stage 112, 132 in the respective figures. For the ease of discussion and sake of brevity, additional filter stages and additional details of a filter stage are not shown in FIGS. 8 and 9. However, one skilled in the art may observe that a filter stage 112 or 132 may be similar to one of the filter stages 70 (FIG. 6) or 86 (FIG. 7), or any other filter stage configuration not shown or discussed herein, but could be readily apparent to one skilled in the art from the discussion provided herein. Further more, as mentioned before, the filter stages 112, 132 may be, for example, bandpass or bandstop filter stages as desired.

In the embodiments of FIGS. 8 and 9, sensing a change in the filter operating temperature may be achieved through a temperature sensor (116 or 136) embedded within the respective filter housing (110 or 130). As discussed in more detail herein below, the sensed temperature value may be used in equation (2) above to calculate the filter stage's wavelength drift corresponding to the measured value of the operating temperature. The calculated wavelength drift may then be used to obtain a value for adjustment in the filter stage driving voltage so as to compensate for the wavelength drift and, thereby, also compensating for the variations in the operating temperature. Various calculations to obtain the wavelength drift value using equation (2) and providing the corresponding adjustment in driving voltage may be carried out using a control system (114 or 134) that may be also embedded within the respective filter housings (110 or 130) in the embodiments of FIGS. 8 and 9. As noted before, the control system 114, 134 may not necessarily have to be inside the respective filter housing 110 or 130. For example, as mentioned before, an external system controller or processor (e.g., the system controller 68 in the embodiment of FIG. 5) may be suitably configured to perform all the functionalities of a control system (114 or 134). However, it may be preferable to have the temperature sensors 116, 136 embedded within the respective filter housings 110, 130 so as to obtain more accurate temperature measurements of the filter operating temperature.

In the embodiments of FIGS. 8 and 9, the control systems 114 and 134, respectively, are passive control systems. The environmental temperature is first sensed by the temperature sensor (116 or 136) and provided to the respective control system (114 or 134). The control system (114 or 134) may then determine the temperature difference value (ΔT) by subtracting the calibration temperature value from the sensed temperature value. The predetermined values of temperature coefficient (γ) for the respective filter stage and the peak transmission wavelength (λₛₑₜ) to which the filter stage is configured to be tuned may be stored in a memory (not shown) in the control system (114 or 134). In one embodiment, the control system (114 or 134) may compute the filter stage-specific peak transmission wavelength based on an input received from a user as to the desired peak transmission wavelength of the overall filter unit. It may be observed that each filter stage within the entire filter configuration may have slightly different peak transmission wavelengths, which, in aggregate, may achieve the desired final peak transmission wavelength for the overall filter unit including such filter stages.

Thus, based on the values of ΔT, γ, and λₛₑₜ, the respective control system (114 or 134) may compute the drift in peak transmission position (Δλₚ) of the corresponding filter stage (112 or 132) using the empirical relationship given in equation (2) hereinbefore. In one embodiment, the control system (114 or 134) may be configured to store a look-up table (not shown in FIGS. 8 or 9) for each filter stage in the filter housing. The look-up table may store drive voltage values corresponding to a set of wavelength drift values (Δλₚ) of the corresponding filter stage. The look-up table may be constructed during filter design and stored as a set of values in a memory (not shown) of the respective control system (114 or 134). In one embodiment, to construct a look-up table, a number of operating temperature values may be applied to a filter stage and corresponding wavelength drifts observed. Thereafter, filter stage's drive voltage may be varied in a manner to compensate for the wavelength drifts. All such drive voltage values corresponding to wavelength drifts at a number of operating temperature values may be stored in the look-up table, which can be later consulted by the control system (114 or 134) to obtain the drive voltage value corresponding to the calculated wavelength drift (Δλₚ) as mentioned hereinabove. The control system may then apply (through appropriate voltage source, e.g., the voltage source 105 in the embodiment of FIG. 7) the newly obtained drive voltage value (from the look-up table) to the filter stage. In this manner, temperature compensation at run-time may be provided for various filter stages in a filter unit (110 or 130). In an alternative embodiment, instead of the actual drive voltage value corresponding to a wavelength drift value, the look-up table may store differential voltage values relative to the filter stage driving voltage value at the calibration temperature. In such an embodiment, the control system (114 or 134) may first obtain the differential drive voltage value from the look-up table corresponding to a calculated wavelength drift value (Δλₚ) from, and, then, correspondingly increase or decrease the filter stage drive voltage according to the differential amount obtained from the look-up table so as to accomplish filter peak position substantially close to that obtained at the calibration temperature so as to maintain transmission peak stability throughout a range of operating temperature values.

Thus, as discussed above, the set wavelength (λₛₑₜ) in the control system may be adjusted to compensate for drift of peak position of all filter stages, based on the empirically determined relationship between the drift in the peak position and the environmental temperature change as given by equation (2) hereinbefore. The adjustment in the set wavelength in the control system may be ultimately converted to the adjustment of control voltage on all stages of a LC-based filter unit (e.g., the filter unit 110 or 130) through the corresponding filter stage-specific control lookup table as discussed above.

It is observed from the discussion above that the control signal (from the control system 114, 134) is applicable to an individual stage as opposed to an individual liquid crystal optical component or element within the stage. For example, in the embodiment of FIG. 9, the filter stage 132 has six (6) individual liquid crystal variable retarders 140, 142, 144, 146, 148, 150. However, the six LC retarders are controlled by only three (and not six) control signals 137, 138, 139. These control signals 137-139 may be referred to as “control channels” for the respective filter stage 132. The control channels may be used to apply adjusted driving voltage values to compensate for temperature variations. In the embodiment of FIG. 8, there are two control channels 126, 127 for the filter stage 122. In other words, the four LC elements 118, 120,122, 124 may be controlled using just two control signals 126, 127 as shown in FIG. 8. In one embodiment, the LC elements that are controlled by a common control signal may be substantially similar in engineering details. The stage-wise control scheme may simplify the filter control system and substantial cost savings may be achieved by reducing the labor to calibrate and fabricate the filter unit. However, the stage-wise control scheme may require highly identical precision fix retarders and liquid crystal variable retarders. Thus, the stage-wise control scheme according to one embodiment of the present disclosure uses the empirically determined relationship (e.g., equation (2) given above) between the transmission peak wavelength shift of a particular filter stage (not of any individual liquid crystal component within the stage) as a function of environmental temperature change so as to correct for temperature-induced wavelength drifts in the system.

FIG. 10 shows illustrative electro-optical response plots 152, 154, 156, 158 of an exemplary filter stage over a range of control (drive) voltages for that filter stage. In FIG. 10, the transmission peak wavelength is used as the control parameter to describe effects of environmental temperature variations. The filter stage in the embodiment of FIG. 10 was similar in configuration to the filter stage 132 in the exemplary embodiment in FIG. 9 (i.e., with six liquid crystal variable retarders and three control channels). In FIG. 10, the plots 152 and 154 indicate a “normal” or “reset” position of electro-optical response (transmission peak wavelength vs. drive or control voltage) of the filter stage at two exemplary operating temperatures (25° C. and 40° C., respectively). In one embodiment, the calibration temperature is 25° C.

With reference to the “reset” plot 152, the control voltage values corresponding to three control signals (e.g., control channels similar to the channels 137-139 in FIG. 9) are depicted by three dots 162-164 on the plot 152. Similar control signal “reset” values may be plotted for the plot 154; however, for ease of discussion, only the 25° C. plot 152 is discussed herein. Each dot on the plot 152 may represent a discrete look-up table entry (e.g., in the memory of the control system 134 in FIG. 9) for a desired transmission peak wavelength associated with a specific control channel. For example, in the embodiment of FIG. 9, each of the control channel 137-139 may have a slightly different transmission peak wavelength associated therewith. Thus, each control channel 137-139 may apply a slightly different control voltage (using the temperature compensation methodology based on equation (2) as discussed hereinbefore with reference to FIGS. 8 and 9) to the associated variable retarder elements (e.g., elements 140 and 142 controlled by the control signal 137, elements 144 and 146 controlled by the control signal 138, etc.) as can be seen by the positions of the dots 162-164 on plot 152, wherein dots 162-164 may correspond to control voltages applied through control channels 137-139, respectively. However, the overall transmission peak of the entire filter stage 132 may remain invariant even when there are slightly different transmission peak wavelengths for individual filter element pairs (corresponding to three control channels 137-139 in FIG. 9). In other words, the cumulative effect of transmissions peaks of individual filter elements may result in a single value for the desired transmission peak wavelength of the filter stage 132. It is noted here that, in a similar manner, different filter stages within the filter 130 may also have slightly differing transmission peaks, all of which combine to result in a single, desired peak transmission wavelength of the entire filter unit 130.

As mentioned before, a control system (e.g., the control system 134 in FIG. 9) may be suitably programmed with information about relevant data points in a filter stage's electro-optical response plots (e.g., the plots 152, 154, etc. in FIG. 10), so as to calculate drive voltage values at individual control channels for that filter stage during a temperature compensation operation. In one embodiment, the value of a tuned wavelength of a pair of filter stage elements (e.g., elements 140 and 142 in FIG. 9) may be represented by “λₛₑₜ” in equation (2) above and corresponding wavelength drift and drive voltage value may be calculated for the respective control channel in a manner similar to that discussed hereinbefore with reference to discussion of filter stage-based temperature compensation in the embodiments of FIGS. 8-9. Alternatively, in one embodiment, the drive voltage value calculated for a given filter stage may be further divided into corresponding values for associated control channels so as to obtain the desired overall transmission peak for that filter stage. In such an embodiment, the respective control system (e.g., the control system 134 in FIG. 9) may store one or more look-up tables to “translate” a drive voltage value into a set of corresponding discrete control channel values.

It is noted here that in frequency drift-based calculations according to equation (2) above, it may be possible that a “drift” in electro-optical characteristics of a filter stage may be observed. Referring to FIG. 10, it is seen that over a period of time, the reset plots 152, 154 may “drift” to corresponding plots 156 and 158. In other words, during operation of an LC-based tunable optical filter over a lengthy time period, the transmission peak wavelength of a filter stage may significantly shift from its “reset” position, thereby also significantly increasing the drive voltage associated with control channels for the filter stage. For example, the nine dots (162A through 164C) on plot 156 represent three sets of drive (control) voltage values—each set containing three drive voltage values (162A, 163A, 164A; 162B, 163B, 164B; and 162C, 163C, 164C), wherein each of the three drive voltage values in a set represents the control signal value at corresponding one of the control channels 137-139 (FIG. 9) for a different filter stage peak transmission wavelength. For example, the values at points 162A, 162B, and 162C represent control voltages associated with the control channel 137 and corresponding to the “normal” position 162 at different operational times, and so on. Similar groups of data points on plot 158 are not plotted in FIG. 10 just for ease of discussion.

Thus, upon comparison of plots 152 and 156, it is seen that a control voltage may reach a point on the plot 156 when it may need to be “reset” to its corresponding position on plot 152 for the same transmission peak wavelength. Such resetting not only reduces the applied drive voltage (thereby reducing, for example, energy consumption and heat generation within the filter stage), but also maintains operational stability of the filter stage (by preventing excessive voltages from being applied to the filter stage or by controlling drive voltage increases within a limit). It is seen from the exemplary arrow 160 in FIG. 10 that, at reset position, the drive voltage 162C may be reduced to its “reset” value at 162, which may result in a discontinuity in the voltage applied through the corresponding control channel 137 (FIG. 9). Furthermore, the reset magnitudes for different control signals (associated with different control channels 137-139) may be different as can be seen from the position of various control voltage points on plots 152 and 156. In any event, as discussed before, the transmission peak wavelength of the overall filter stage may remain control invariant.

In one embodiment, instead of different control (or drive) voltages for different groups of variable retarders in a filter stage (as discussed hereinabove with reference to the configuration in FIG. 9 and the plots in FIG. 10), there may be only a single control channel (not shown) applied to all variable retarders in the filter stage, thereby supplying a single drive voltage to all LC variable elements in the filter stage. Similar other configurations for control channels may be devised as per design requirements.

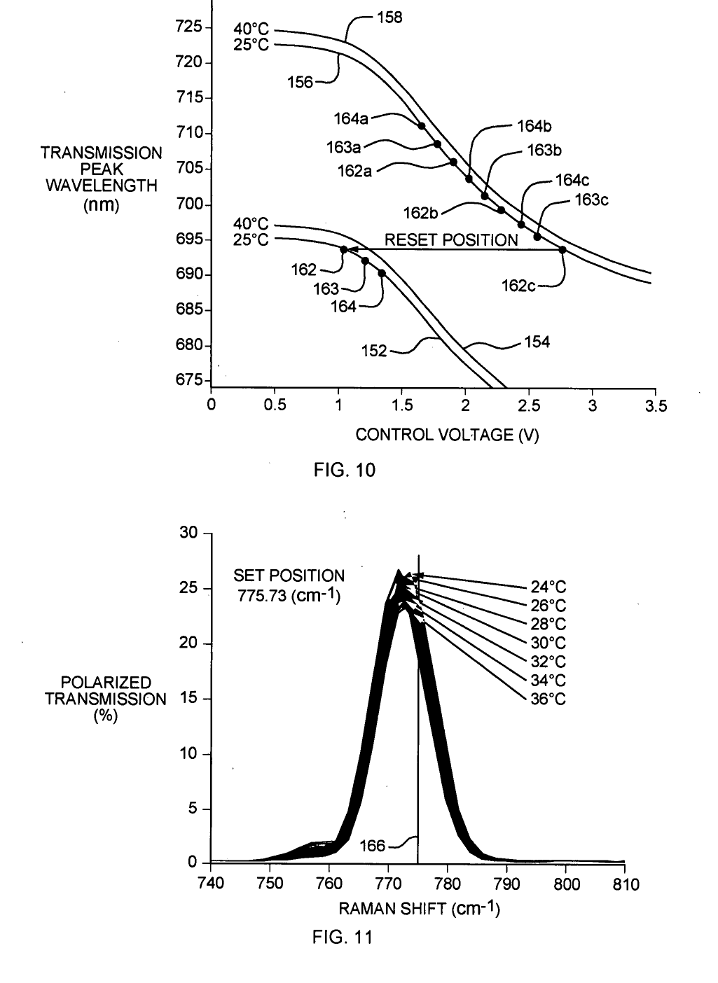

FIG. 11 illustrates transmission plots over a wide range of operating temperatures of an exemplary LC-based tunable filter stage employing temperature compensation mechanism according to one embodiment of the present disclosure. In the filter stage embodiment of FIG. 11, a stage-wise temperature compensation based on equation (2) and discussed in more detail in conjunction with exemplary embodiments in FIGS. 8 and 9 was implemented. The preferable operating temperature range was from 25° C. to 45° C., and the transmission plot data were collected at a rate of 1 data point/5 min over a total of 10 hours. It is observed from the plot in FIG. 11 that the transmission peak position is maintained substantially constant over a wide range of operating temperatures. The filter stage's set wavelength (i.e., “λₛₑₜ” in equation-2 above) in the control system (e.g., similar to the control system 114 or 134 in FIGS. 8 or 9, respectively) was 775.73 cm⁻¹ as indicated by the vertical line 166 in FIG. 11. Thus, it is seen from FIG. 11 that the drift of filter stage's transmission peak position due to temperature variations is significantly contained using the temperature compensation-based filter stage peak stabilization methodology discussed herein.

The foregoing describes various embodiments of a temperature compensation mechanism and associated methodology to provide compensation for temperature-induced drifts in the peak transmission wavelength of a liquid crystal (LC)-based tunable optical filter stage. The filter-staged based methodology uses a simple, empirical mathematical relationship that represents thermal effects on an LC-based filter stage by taking into account a relationship among the LC material's actual temperature coefficient (of thermal expansion), the operating temperature variation, and wavelength drift attributable to the temperature variation. In one embodiment, a control channel based mechanism is used to provides appropriate temperature compensation to a liquid crystal-based tunable optical filter by accurately calculating LC driving voltage values needed for temperature compensation and then supplying the calculated drive voltage to drive various LC components in the filter. As mentioned before, the teachings of the present disclosure may be implemented whenever filtering properties of liquid crystals are utilized such as, for example, in a liquid crystal display (LCD), in an LC-based spectroscopy system, etc.

While the disclosure has been described in detail and with reference to specific embodiments thereof, it will be apparent to one skilled in the art that various changes and modifications can be made therein without departing from the spirit and scope of the embodiments. Thus, it is intended that the present disclosure cover the modifications and variations of this disclosure provided they come within the scope of the appended claims and their equivalents.

What is claimed is:

1. A method comprising:
sensing an operating temperature of a filter stage of a liquid crystal-based tunable optical filter;
determining a difference temperature by subtracting a calibration temperature from said operating temperature, wherein said calibration temperature indicates a temperature value at which said tunable optical filter is calibrated;
calculating a wavelength drift of said filter stage corresponding to said difference temperature by using an empirical relationship between said difference temperature and said wavelength drift, wherein said wavelength drift indicates a deviation from a predetermined peak wavelength of said filter stage at said calibration temperature; and
providing a compensation for said calculated wavelength drift by adjusting a driving voltage of said filter stage commensurate with the value of said wavelength drift so as to substantially minimize said wavelength drift at said operating temperature from said predetermined peak wavelength.

2. The method of claim 1, wherein sensing said operating temperature includes:
using a temperature sensor inside a housing of said tunable optical filter to sense said operating temperature.

3. The method of claim 1, wherein said empirical relationship is represented by a mathematical relationship among said difference temperature, a predetermined temperature coefficient of said filter stage, said predetermined peak wavelength, and said wavelength drift.

4. The method of claim 3, wherein said mathematical relationship is given by: Δλₚ=γΔTλₛₑₜ, wherein “Δλₚ” represents said wavelength drift, “γ” represents said predetermined temperature coefficient, “ΔT” represents said difference temperature, and “λₛₑₜ” represents said predetermined peak wavelength.

5. The method of claim 1, wherein providing said compensation includes:
converting said wavelength drift into a corresponding first drive voltage value using a look-up table; and
applying said first drive voltage value to said filter stage as part of adjusting said drive voltage of said filter stage.

6. The method of claim 5, wherein said first drive voltage value includes a first plurality of drive voltage values for said filter stage, wherein said filter stage includes a second plurality of liquid crystal elements, and wherein applying said first drive voltage value includes:
applying said first plurality of drive voltage values to said second plurality of liquid crystal elements in said filter stage, wherein said first plurality of drive voltage values is less in number than said second plurality of liquid crystal elements.

7. The method of claim 6, wherein applying said first plurality of drive voltage values includes applying each of said first plurality of drive voltage values to corresponding two or more liquid crystal elements in said second plurality of liquid crystal elements.

8. A system comprising:
a liquid crystal-based tunable optical filter having a filter stage containing a plurality of liquid crystal elements;
a temperature sensor for sensing an operating temperature of said filter stage; and
a control unit configured to receive said operating temperature from said temperature sensor and further configured to:
determine a difference temperature by subtracting a calibration temperature from said operating temperature, wherein said calibration temperature indicates a temperature value at which said tunable optical filter is calibrated;
calculate a wavelength drift of said filter stage corresponding to said difference temperature by using an empirical relationship between said difference temperature and said wavelength drift, wherein said wavelength drift indicates a deviation from a predetermined peak wavelength of said filter stage at said calibration temperature; and
provide a compensation for said calculated wavelength drift by adjusting a driving voltage of said filter stage commensurate with the value of said wavelength drift so as to substantially minimize said wavelength drift at said operating temperature from said predetermined peak wavelength.

9. The system of claim 8, further comprising a housing including said tunable optical filter, said temperature sensor, and said control unit.

10. The system of claim 8, wherein said empirical relationship is represented by a mathematical relationship given by:
Δλₚ=γΔTλₛₑₜ, wherein “Δλₚ” represents said wavelength drift, “γ” represents a predetermined temperature coefficient of said filter stage, “ΔT” represents said difference temperature, and “λₛₑₜ” represents said predetermined peak wavelength.

11. The system of claim 8, wherein said control unit is configured to store a look-up table containing a plurality of entries linking a plurality of wavelength drift values to a corresponding plurality of drive voltage values, and wherein said control unit is further configured to:
determine a first drive voltage value corresponding to said calculated wavelength drift using said look-up table; and
facilitate application of said first drive voltage value to said filter stage as part of adjusting said drive voltage of said filter stage.

12. The system of claim 11, wherein said first drive voltage value includes a first plurality of drive voltage values for said filter stage, and wherein said control unit is configured to apply said first drive voltage value to said filter stage by applying each of said first plurality of drive voltage values to corresponding two or more liquid crystal elements in said plurality of liquid crystal elements in said filter stage.

13. The system of claim 8, further comprising:
an illumination source for providing a plurality of illuminating photons;
a focusing optics optically coupled to said illumination source to focus said illuminating photons onto a sample when placed at a focusing location of said focusing optics; and
a collection optics to collect photons reflected, emitted, scattered, or transmitted from said sample when said sample is placed at said focusing location and illuminated by said plurality of illuminating photons from said focusing optics,
wherein said tunable optical filter is optically coupled to said collection optics to receive said collected photons therefrom and to generate filtered photons from said collected photons, wherein said filtered photons include only those photons from said collected photons that have a wavelength that is substantially equal to said predetermined peak wavelength of said filter stage.

14. The system of claim 13, further comprising:
a spectrometer coupled to said tunable optical filter to receive said filtered photons therefrom and to responsively measure intensity of said filtered photons at said wavelength that is substantially equal to said predetermined peak wavelength.

15. The system of claim 13, further comprising:
an imaging detector optically coupled to said tunable optical filter to receive said filtered photons therefrom and to responsively provide optical data to generate a wavelength-specific spectral image of said sample; and
a display unit coupled to said imaging detector to display said wavelength-specific spectral image of said sample.

16. A data storage medium containing program code, which, when executed by a processor, causes said processor to perform the following:
obtain from a temperature sensor an operating temperature of a filter stage of a liquid crystal-based tunable optical filter;
determine a difference temperature by subtracting a calibration temperature from said operating temperature, wherein said calibration temperature indicates a temperature value at which said tunable optical filter is calibrated;
calculate a wavelength drift of said filter stage corresponding to said difference temperature by using an empirical relationship among said difference temperature, a predetermined temperature coefficient of said filter stage, a predetermined peak wavelength of said filter stage at said calibration temperature, and said wavelength drift, wherein said wavelength drift indicates a deviation from said predetermined peak wavelength; and
provide a compensation for said calculated wavelength drift by adjusting a driving voltage of said filter stage commensurate with the value of said wavelength drift so as to substantially minimize said wavelength drift at said operating temperature from said predetermined peak wavelength.

17. The data storage medium of claim 16, wherein said program code, when executed by said processor, causes said processor to further perform the following:
convert said calculated wavelength drift into a corresponding first drive voltage value using a look-up table; and
facilitate application of said first drive voltage value to said filter stage as part of adjusting said drive voltage of said filter stage.

18. A liquid crystal-based tunable optical filter, comprising:
a filter housing including:
a filter stage comprising a plurality of paired birefringent retarders disposed between at least two polarizers, wherein each paired retarder includes a fixed retarder and a liquid crystal tunable retarder, and wherein each liquid crystal retarder is tunable independently of other liquid crystal retarders in the filter stage;
a temperature sensor for sensing an operating temperature of said filter stage; and
a control unit configured to receive said operating temperature from said temperature sensor and further configured to:
determine a difference temperature by subtracting a calibration temperature from said operating temperature, wherein said calibration temperature indicates a temperature value at which said tunable optical filter is calibrated;
calculate a wavelength drift of said filter stage corresponding to said difference temperature by using an empirical relationship between said difference temperature and said wavelength drift, wherein said wavelength drift indicates a deviation from a predetermined peak wavelength of said filter stage at said calibration temperature; and
provide a compensation for said calculated wavelength drift by adjusting driving voltages of liquid crystal retarders in said filter stage commensurate with the value of said wavelength drift so as to substantially minimize said wavelength drift at said operating temperature from said predetermined peak wavelength.

19. The tunable optical filter of claim 18, wherein said empirical relationship is represented by a mathematical relationship given by:
Δλₚ=γΔTλₛₑₜ, wherein “Δλₚ” represents said wavelength drift, “γ” represents a predetermined temperature coefficient of said filter stage, “ΔT” represents said difference temperature, and “λₛₑₜ” represents said predetermined peak wavelength.

20. The tunable optical filter of claim 18, wherein said control unit is configured to store a look-up table containing a plurality of entries linking a plurality of wavelength drift values to a corresponding plurality of drive voltage values, and wherein said control unit is further configured to:
determine a drive voltage value corresponding to said calculated wavelength drift using said look-up table; and
facilitate application of said drive voltage value to each liquid crystal retarder in said filter stage as part of adjusting drive voltages of liquid crystal retarders in said filter stage.

21. The tunable optical filter of claim 18, wherein said control unit is configured to store a look-up table containing a plurality of entries linking a plurality of wavelength drift values to a corresponding plurality of drive voltage values, and wherein said control unit is further configured to:
determine a first plurality of drive voltage values corresponding to said calculated wavelength drift using said look-up table; and
facilitate application of each drive voltage value in said first plurality of drive voltage values to corresponding two or more liquid crystal retarders in said filter stage as part of adjusting drive voltages of liquid crystal retarders in said filter stage.

22. A programmable processor, which, upon being programmed, is configured to perform the following:
obtain from a temperature sensor an operating temperature of a filter stage of a liquid crystal-based tunable optical filter;
determine a difference temperature by subtracting a calibration temperature from said operating temperature, wherein said calibration temperature indicates a temperature value at which said tunable optical filter is calibrated;
calculate a wavelength drift of said filter stage corresponding to said difference temperature by using a mathematical relationship given by: λΔₚ=γΔTλₛₑₜ, wherein “Δλₚ” represents said wavelength drift, “γ” represents a predetermined temperature coefficient of said filter stage, “ΔT” represents said difference temperature, and “λₛₑₜ” represents a predetermined peak wavelength of said filter stage at said calibration temperature, wherein said wavelength drift indicates a deviation from said predetermined peak wavelength; and
provide a compensation for said calculated wavelength drift by adjusting a driving voltage of said filter stage commensurate with the value of said wavelength drift so as to substantially minimize said wavelength drift at said operating temperature from said predetermined peak wavelength.

23. The processor of claim 22, wherein said processor is configured to store a look-up table containing a plurality of entries linking a plurality of wavelength drift values to a corresponding plurality of drive voltage values, and said processor, upon being programmed, is configured to further perform the following:
convert said calculated wavelength drift into a corresponding drive voltage value using said look-up table; and
facilitate application of said drive voltage value to said filter stage as part of adjusting said drive voltage of said filter stage.
